(19) United States
(12) Patent Application Publication
(10) Pub. No.: US 2008/0095901 A1
(43) Pub. Date: Apr. 24, 2008

(54) Method for Stabilizing and Preventing Coagulation of Proteins in Milk

(75) Inventors: Frank Boerboom, Zeist (NL); Elize W. Bontenbal, Wageningen (NL)

Correspondence Address: OLIFF & BERRIDGE, PLC, P.O. BOX 320850, ALEXANDRIA, VA, 22320-4850, US

(73) Assignee: Purac Biochem B.V>, Gorinchem (NL)

(21) Appl. No.: 11/666,079

(22) PCT Filed: Nov. 2, 2005
(86) PCT No.: PCT/EP05/55708

§ 371 Date: May 16, 2007

Related U.S. Application Data
(60) Provisional application No. 60/623,866, filed on Nov. 2, 2004.

(51) Int. Cl. A23C 9/152; A23C 11/10; A23C 9/154

(52) U.S. Cl. 426/271; 426/471; 426/580

(57) ABSTRACT

The invention pertains to a method for stabilizing and preventing coagulation of proteins in milk comprising a coagulant consisting of >400 ppm of a non-complexed divalent cation, and/or an amount of an acid giving a pH<6.2 to the milk, comprising the steps: a) adding to the milk 0.0005 to 0.1% carrageenan and/or gellan as a hydrocolloid mixture comprising at least 0.2% carrageenan and/or gellan based on the total weight of the hydrocolloid mixture, and at least one of the divalent cation and the acid to obtain a solution or dispersion; b) at least partially precipitating proteins from the solution or dispersion by heating the milk at 120-150° C. for 2 to 120 seconds; c) cooling the mixture of step b) to below 100° C., preferably to below 40° C.; and d) applying shear or elongation onto the precipitate to obtain a stabilized divalent cation protein solution or dispersion. The invention further relates to stabilized Ca-enriched milk and the use thereof in spray drying.

### FIELD OF THE INVENTION

The present invention relates to a method for stabilizing and preventing coagulation of proteins in milk, to a stabilized coagulant-containing milk, and to use of said milk.

### BACKGROUND OF THE INVENTION

A common problem with obtaining milk and milk products is the coagulation of milk proteins during or after processing the milk, as a consequence of the processing conditions and/or the addition of additives, such as calcium. Many references are known to obtain calcium-fortified milk. In WO 03/090551 calcium-fortified protein-containing beverages and processes for making them are disclosed. Such beverages are stable, contain high levels of soluble calcium, and are produced using a process that is similar to that used to produce regular dairy milk.

In WO 02/43503 a method for producing the calcium-fortified yogurt is provided wherein a fine powdered insoluble calcium salt is admixed with a milk blend prior to fermentation. The yogurt is prepared by conventional fermentation.

In US 2003165597 a calcium and/or nutritional mineral fortified milk or milk powder product utilizes pyrophosphates or orthophosphates in combination with maintenance of pH within the range of 6.5 to 7.5 to render the milk heat stable. Additional calcium and/or nutritional mineral are added in soluble form either before or after the phosphate addition.

Such beverages can be consumed as it is or can be easily incorporated into other food or beverage products the preparation of stable calcium-enriched protein-containing food products such as milk products and soy products, comprising milk, yogurt drinks, puddings, and the like.

However, the above references provide methods for calcium enrichment that has up to now rendered physically instable products. Free calcium can react with the caseins or soy proteins resulting in the formation of insoluble calcium-protein precipitates.

The invention provides in a solution to this problem and provides physically stable milk having high contents of calcium or other divalent cations.

In EP 1031284 a method for producing a soy milk is disclosed, comprising adding a coagulant to a raw soy milk, homogenizing, treating with direct high-temperature flash heating using steam, and then homogenizing the mixture. This method only makes use of addition of calcium or magnesium salts and is used to overcome the problems concerning the flavor of soy milks. This method, however, needs the use of an extra homogenization step prior to heating the soy milk and is not used for stabilizing the divalent ions in the milk.

There are also methods known for increasing the amount of Ca²⁺ ions by using chelators for Ca ions, keeping these in solution. This method is unsuitable when large amounts of Ca have to be introduced, such as more than 600 ppm, more particularly more than 1000 or even 2000 ppm Ca²⁺. When such large amount are brought into the milk using chelators or other complexing agents taste can be adversely affected (bad taste), and moreover often coagulation still occurs after a certain shelf life. Further, in some countries many of these chelators are not allowed in milk.

### BRIEF DESCRIPTION OF THE INVENTION

To this end the invention provides a method for stabilizing and preventing coagulation of proteins in milk comprising a coagulant consisting of >400 ppm of a non-complexed divalent cation, and/or an amount of an acid giving a pH<6.2 to the milk, comprising the steps:

a) adding to the milk 0.0005 to 0.1% carrageenan and/or gellan as a hydrocolloid mixture comprising at least 0.2% carrageenan and/or gellan based on the total weight of the hydrocolloid mixture, and at least one of the divalent cation and the acid to obtain a solution or dispersion;

b) at least partially precipitating proteins from the solution or dispersion by heating the milk at 120-150° C. for 2 to 120 seconds;

c) cooling the mixture of step b) to below 100° C., preferably to below 40° C.; and

d) applying shear or elongation onto the precipitate to obtain a stabilized divalent cation protein solution or dispersion.

### DETAILED DESCRIPTION OF THE INVENTION

Within the context of the present specification the term milk refers to any milk, including bovine, soy, goat, equine, constructed milk and milk products thereof. Bovine and soy milk and milk products thereof are preferred.

It is preferred that an amount of coagulant, such as a divalent cation, is added that is sufficient to completely precipitate the proteins from solution in particle aggregates. The term “completely” means in this respect that the particle aggregates will not change anymore on decrease or increase of the calcium concentration, pH or heat treatment.

The method of the invention even prevents coagulation of proteins in milk comprising more than 400 ppm of divalent cations, or both >400 ppm of a divalent cation and an amount of an acid giving a pH<6.2. The method, unlikely the prior art methods, is thus suitable to produce very high coagulation agent contents without physically destabilize the proteins. The method easily can produce milk having a calcium content 150% of such milk produced by prior art methods.

The divalent cations are preferably calcium and magnesium ions, calcium being the preferred ion. These ions are preferably added as their lactate or gluconate salt, but mixtures thereof can also be used. Calcium lactate is the most preferred source of divalent cations. The divalent ions are non-complexed, which mean that they are not kept in the solution by complex-forming or chelating using complex formers and chelators. Complex formers and chelators have the disadvantage that they can adversely affect the taste of the milk, are ineffective in preventing coagulation after a certain period of time, and further some chelators may have unfavorable health effects and are therefore not allowed in some countries. It is therefore also an object of the invention to provide a method for obtaining milk having high calcium or other cation content without adding chelators or other complex forming products.

The acid may be any acid that is acceptable in food, such as acetic acid, lactic acid, citric acid, tartaric acid, malic acid, phosphoric acid, GDL (glucono delta lactone), fumaric acid, and lactobionic acid. During the first step, for instance, calcium is added as calcium lactate or calcium gluconate, in amounts as high as 200% of what was the maximum amount according to the prior art methods, preferably at a pH between about 5.5 and 7.5, more preferably between 6 and 7. In this manner amounts of divalent cations up to 2000 ppm and more can easily be added to milk without any tendency to give coagulation.

When an acid is added during the first step the pH of the milk must be lower than 6.2, preferably between and 6.2 and 5.5.

If both a divalent cation and an acid are added the amount of divalent ion is preferably >400 ppm, whereas the amount of acid leads to a pH that is preferably less than 6.2.

The precipitate that is obtained in this manner is subjected to high shear and elongation under homogenizing UHT conditions (ultra-high temperature treatment). Preferably, this is performed in a homogenizer, for instance at elevated pressures of 50 bar or higher using a conventional homogenizer. Usually, temperatures in the range of 120 to 150° C. are used for 2 to 120 seconds. Preferred temperatures and times are 135-145° C. for 5-10 seconds.

It is necessary to add a hydrocolloid together with the divalent cation to the milk, preferably but not restricted to modified starch, dextrins or maltodextrins 0.25-6%, carrageenan 0.0005-0.1%, pectin 0.08-0.4%, guar 0.01-0.10%, locust bean gum 0.02-0.4%, carboxymethyl-cellulose (CMC) 0.2-3%, xanthan 0.01-0.3%, gellan 0.0005-0.1% and traganth gum 0.02-0.3%, or mixtures thereof. This addition is necessary to increase the physical stability of the proteins further. The added hydrocolloid must at least comprise 0.0005 to 0.1% carrageenan and/or gellan.

In another embodiment the invention pertains to a method for adding divalent cation to milk to stabilize and prevent coagulation of proteins in milk comprising the steps:

a) adding the mixture of the hydrocolloid and the coagulant to milk to obtain a solution or dispersion;

b) at least partially precipitating proteins from the solution or dispersion by heating the milk;

c) cooling the milk to below 100° C., preferably to below 40° C.; and

d) applying shear or elongation onto the precipitate to obtain a stabilized coagulant-containing protein solution or dispersion.

Such method may provide a stabilized Ca-enriched milk comprising >600 ppm of Ca²⁺ ions, which amount of calcium was not possible using the prior art methods of producing milk without precipitation of proteins. Amounts up to 2000 ppm or more are possible according to the method of the invention.

The milk contains 0.0005 to 0.1% of a carrageenan and/or gellan, which is added as such or as a mixture of hydrocolloids. Such mixture at least comprises 0.2% of a carrageenan and/or gellan based on the total weight of the hydrocolloids. Preferred the milk contains 0.001 to 0.05% carrageenan and/or gellan. More preferred the milk contains 0.015 to 0.025% carrageenan and/or gellan.

The milk of the invention can be used for any purpose that is common for milk, i.e. milk and milk products including yogurt, ice creams, puddings, deserts, milk powder, and the like. The milk is particularly suitable for making cat milk and for using in spray-dry processes, for instance for making milk powder.

### EXAMPLES

The invention will further be illustrated by the following non-restrictive examples

Materials

The premix and the medium heat whole milk powder were obtained from Masterfoods. Lactic acid, calcium gluconate (Gluconal CAA-P-IN; 9% calcium) and calcium lactate (Puracal® PP fine; 13.7% calcium) were obtained from Purac. The carrageenan preparation (Satiagel® ABN16) was purchased from Degussa and the enzyme preparation lactase (Maxilact®5000) from DSM. Carrageenan preparation obtained from seaweed can be used, which carrageenan can be of a different type, such as kappa, iota, and lambda carrageenan, in refined or unrefined form. All gellan types, refined and unrefined, can be used.

Experimental Methods

Testing of Physical Stability

The physical stability of the calcium-enriched milks was observed visually directly after preparation (black plate), after centrifugation (2000 g, 10 min) and after storage for a week at 30° C.

Testing Other Characteristics

The viscosity of the produced batches was analyzed by the use of a rotoviscometer, the particle size distribution was determined by the use of static light-scattering and optical microscopic pictures were made.

Preliminary Calcium—Heat Coagulation Trials at Lab-Scale

Medium heat whole bovine milk powder (0.32 kg) was added to water of 48° C. (2.26 kg). The milk powder was mixed in by the use of a mechanical stirrer. Subsequently, the milk was cooled to <10° C. Lactase was added (0.12%) and the milk was incubated overnight at 7° C. under stirring.

After hydrolysis of lactose, the milk was divided over 4 batches to which calcium preparations were added and the pH was set (sodium hydroxide; lactic acid):

1 0.5 kg lactase-treated milk + calcium gluconate pH 6.7

2 0.5 kg lactase-treated milk + calcium gluconate pH 6.2

3 0.5 kg lactase-treated milk + calcium lactate pH 6.7

4. 0.5 kg lactase-treated milk + calcium lactate pH 6.2

The concentration calcium determined in the milk was 1230 mg/kg. An addition of 20% to normal milk is 246 mg calcium per kg of milk. This corresponds with an addition of 1.80 g of calcium lactate or 2.73 g of calcium gluconate per kg of milk.

The calcium-enriched milks were mechanically stirred for 30 minutes after which the pH was set to pH 6.2 or to the pH of the starting milk, pH 6.7.

Milks 1-4 were put in a water bath of 80° C. Around 70° C. the milks having a pH of 6.2 started to coagulate/destabilize. The milks were stable at pH 6.7. Heating in an oil bath of 140° C. destabilized these milks after 1-2 minutes (standard milk is stable for 12-15 minutes).

Destabilized milk (pH 6.2, 80° C.) was homogenized by the use of an ultra-turrax. This resulted in homogeneous, smooth (small particles), and somewhat more viscous milk. Addition of 0.02% carrageenan (at 80° C., and after cooling) resulted in more viscous milk. Addition of 0.02% carrageenan at calcium-enriched milk (pH 6.2) before heating prohibited the destabilization of this milk in a water bath of 80° C.

In conclusion, the milk is indeed less stable after enrichment with 20% calcium, especially at pH 6.2. Homogenization of the coagulated/destabilized milk appears possible and carrageenan appears to be able to stabilize calcium-enriched milk.

Preliminary Calcium—Heat Coagulation Trials at Pilot Plant Scale

As the coagulation of the milk needs to be complete and at the same time the milk needs to be readily processable during heat-treatment, preliminary heating trials were carried out at a tubular heating system (Combitherm). The lab trials had shown that at UHT conditions (including the pre-heating step) the calcium-enriched milk will coagulate/destabilize.

Also it appeared possible to homogenize coagulate. Therefore, different types of calcium-enriched milks were given a standard UHT-treatment (preheater 85° C.; 5 sec 142° C.) and the homogenization conditions were varied (75, 100/25 and 200/30 bar) to obtain homogenous and smooth milk. In addition to the experiments described in the project proposal, also the addition of carrageenan before the UHT-treatment and the addition of 30% calcium instead of 20% were tested.

Medium heat whole bovine milk powder (25.6 kg) was added to 180.8 kg water of 48° C. The milk powder was mixed in by the use of a mechanical stirrer. Subsequently, the milk was cooled to <10° C. Lactase was added (0.12%) and the milk was incubated overnight at 10° C. under stirring.

After the enzymatic conversion of lactose the milk was split into two batches of 100 kg to which calcium-gluconate (273 g) or calcium-lactate (180 g) were added (extra addition of 20% calcium). Both batches were split into two batches of each 50 kg; the pH of these batches was set at the original pH of the milk, 6.7 or at 6.2 by the use of sodium hydroxide or lactic acid:

1 50 kg lactase-treated milk + calcium gluconate pH 6.7

standard UHT-treatment (preheater 85° C.; 5 sec 142° C.) homogenization at 85° C. and 75, 100/25 or 200/30 bar.

addition of 0.02% carrageenan before UHT-treatment and homogenization; Standard UHT-treatment (preheater 85° C.; 5 sec 142° C.) homogenization at 85° C. and 200/30 bar.

2 50 kg lactase-treated milk + calcium gluconate pH 6.2

standard UHT-treatment (preheater 85° C.; 5 sec 142° C.) homogenization at 85° C. and 75, 100/25 or 200/30 bar.

addition of 0.02% carrageenan before UHT-treatment and homogenization; Standard UHT-treatment (preheater 85° C.; 5 sec 142° C.) homogenization at 85° C. and 200/30 bar.

3 50 kg lactase-treated milk + calcium lactate pH 6.7

standard UHT-treatment (preheater 85° C.; 5 sec 142° C.) homogenization at 85° C. and 75, 100/25 or 200/30 bar.

extra addition of 10% calcium (total of 30% calcium) before UHT-treatment and homogenization; Standard UHT-treatment (preheater 85° C.; 5 sec 142° C.) homogenization at 85° C. and 200/30 bar.

4 50 kg lactase-treated milk + calcium lactate pH 6.2

standard UHT-treatment (preheater 85° C.; 5 sec 142° C.) homogenization at 85° C. and 75, 100/25 or 200/30 bar.

extra addition of 10% calcium (total of 30% calcium) before UHT-treatment and homogenization; Standard UHT-treatment (preheater 85° C.; 5 sec 142° C.) homogenization at 85° C. and 200/30 bar.

UHT-treatment and homogenization of calcium-enriched milk was possible by the use of the Combitherm. The resulting milks were all homogeneous and no clump formation or coagulation was observed. Directly after production, the different milks were poured out on a black surface and no inhomogeneities or differences between the different batches were observed. However, microscopic analysis revealed some clear differences. In all samples particles (μm-size) could be observed (results not shown). Depending on the homogenization conditions an increase in the degree of clustering was observed. The more intense the homogenization, the less clustering was seen.

After storage for three days sedimentation was observed (Table 1). The milks prepared with gluconate showed more sedimentation compared to those prepared with calcium lactate. Also there was more sedimentation at pH 6.2 than at 6.7. Carrageenan appears to be able to stabilize the milks against sedimentation.

TABLE 1
Sedimentation values

| | Sedimentation* |
|---|---|
| Sample | (cm) |
| Calcium gluconate pH 6.7 75 bar | 0.5 |
| Calcium gluconate pH 6.7 100/25 bar | 0.5 |
| Calcium gluconate pH 6.7 200/30 bar | 0.5 |
| Calcium gluconate pH 6.7 200/30 bar + | <0.1 |
| carrageenan | |
| Calcium gluconate pH 6.2 75 bar | 2 |
| Calcium gluconate pH 6.2 100/25 bar | 1.5 |
| Calcium gluconate pH 6.2 200/30 bar | 1 |
| Calcium gluconate pH 6.2 200/30 bar + | 0.5 |
| carrageenan | |
| Calcium lactate pH 6.7 75 bar | 0.3 |
| Calcium lactate pH 6.7 100/25 bar | 0.3 |
| Calcium lactate pH 6.7 200/30 bar | 0.1 |
| Calcium lactate pH 6.7 200/30 bar | 0.1-0.2 |
| (30% calcium) | |
| Calcium lactate pH 6.2 75 bar | 1.5 |
| Calcium lactate pH 6.2 100/25 bar | 2 |
| Calcium lactate pH 6.2 200/30 bar | <0.1 |
| Calcium lactate pH 6.2 200/30 bar | 1.2 |
| (30% calcium) | |

*In 150 ml vials after 3 days of storage at 7° C.

Production of Calcium-Fortified Milk—Experiment I

The effect of extra calcium (20%) was directly tested in cat milk (lactase-treated bovine milk +premix).

The approach was:

Medium heat whole bovine milk powder (6.4 kg) (Masterfoods) was added to water of 48° C. (45.2 kg). The milk powder was mixed in by the use of a mechanical stirrer. Subsequently, the milk was cooled to <10° C. Lactase was added (0.12%) and the milk was incubated overnight at 10° C. while stirring. The lactase-treated milk was divided into three batches of 16 kg. The milks were given a UHT-treatment (preheater 85° C.; 5 sec 142° C.) and a two-steps homogenization (85° C.; 200/30). After the UHT-treatment and homogenization the milk was cooled (5° C.) and three samples of 0.5 L product were taken from each batch (1-3).

1 Reference Milk

16 kg of lactase-treated cat milk (pH 6.7) were heated to 75° C. Premix (181.5 g containing carrageenan (1.7 wt. %), CMC, and dextrin) was added.

2 Milk +20% Calcium

To 16 kg of lactase-treated cat milk 28.7 g of calcium lactate were added. The pH was set at 6.7. The milk was subsequently heated to 75° C. and 181.5 g of premix containing carrageenan, CMC and dextrin (to a total of 98.3 wt. %) were added

3 Milk +20% Calcium +0.02% Carrageenan

To 16 kg of lactase-treated milk 28.7 g of calcium lactate were added. The pH was set at 6.7. The milk was subsequently heated to 75° C. and 181.5 g of premix and 3.2 g of carrageenan were added.

Directly after production, samples were poured out on a black surface. All samples looked stable and no inhomogeneities were observed. Microscopic and light scattering analysis revealed that by the introduction of calcium more particles were found with a size large than homogenized fat particles but smaller than 10 μm. Addition of carrageenan seems to result in more clustering. Table 2 shows a comparison of the reference cat milk to the calcium enriched cat milks. No differences were observed in the different applied sedimentation tests. With other words in these tests the calcium enriched cat milks behaved identical to the reference cat milk.

Determination of the viscosity revealed some differences. An increase was observed after the addition of calcium and after the addition of carrageenan.

TABLE 2
Results of sedimentation test and determination of the viscosity of the samples

| | Sediment | Sediment | Sediment | | |
|---|---|---|---|---|---|
| | (ml) | (ml) | (ml) | Sediment | Viscosity |
| Sample | at 200 g¹ | at 1000 g¹ | at 2000 g¹ | (cm)² | (mPas)³ |
| Lactase treated milk | No | No | <2.5 | Not | 2.5⁴/2.5⁵ |
| (no homogenization) | sediment | sediment | | determined | |
| Cat milk | No | No | 2.5 | No | 8.5⁴/9.5⁵ |
| (reference) | sediment | sediment | | sediment | |
| Cat milk + 20% | No | <0.1 | 2.5 | No | 10.25⁵ |
| calcium | sediment | | | sediment | |
| Cat milk + 20% | No | <0.1 | 2.5 | No | 14.25⁵ |
| calcium + 0.02% | sediment | | | sediment | |
| carrageenan | | | | | |

¹after centrifugation for 10 min at indicated g at 20° C. in 50 ml Greiner centrifuge tubes
²after storage for 1 week at 30° C. at 1 g in a 0.5 L beaker
³at 300 sec⁻¹
⁴measured at production day
⁵measured one day after production

Production of Calcium Fortified Milk—Experiment II

Medium heat whole cat milk powder (19 kg) (Masterfoods) was added to 134 kg of water of 48° C. The milk powder was mixed in by the use of a mechanical stirrer. Subsequently, the milk was cooled to <10° C. Lactase was added (0.12%) and the milk was incubated overnight at 10° C. while stirring. The lactase-treated milk was divided into seven batches of 20 kg. To these batches, different ingredients were added (see below). The milks were given a UHT-treatment (preheater 85° C.; 5 sec 142° C.; sterile conditions) and a two-steps homogenization (85° C.; 200/30). After the UHT-treatment and homogenization the milk was cooled (5° C.) and 6 samples of 0.5 L product were aseptically taken.

1 Reference Milk

20 kg of lactase-treated cat milk was heated to 75° C. Premix (226.8 gram) was added.

2 Milk +20% Calcium

To 20 kg lactase-treated cat milk 35.9 gram calcium lactate was added. The pH was set at 6.7. The milk was heated to 75° C. and 226.8 g of the previously mentioned premix was added.

3 Milk +30% Calcium +0.02% Carrageenan

To 20 kg of lactase-treated cat milk 53.9 g of calcium lactate were added. The pH was set at 6.7. The milk was heated to 75° C. and 226.8 g of premix and 4 g of carrageenan were added.

4 Milk +30% Calcium

To 20 kg of lactase-treated cat milk 53.9 g of calcium lactate were added. The pH was set at 6.7. The milk was heated to 75° C. and 226.8 g of premix were added.

5 Milk +40% Calcium +0.02% Carrageenan

To 20 kg of lactase-treated cat milk 71.8 g of calcium lactate were added. The pH was set at 6.7. The milk was heated to 75° C. and 226.8 g of premix and 4 g of carrageenan were added.

6 Milk +40% Calcium

To 20 kg of lactase-treated cat milk 71.8 g of calcium lactate were added. The pH was set at 6.7. The milk was heated to 75° C. and 226.8 g of premix was added.

7 Lactase-Treated Milk +40% Calcium

To 20 kg of lactase-treated milk 71.8 g of calcium lactate were added. The pH was set at 6.7.

TABLE 3
Results of sedimentation test and determination of the viscosity of the samples

| | Extra | | | | |
|---|---|---|---|---|---|
| | Hydrocolloid | | Sediment | Sediment | Viscosity |
| Sample | carrageenan (%) | Pre-mix⁴ | (ml)¹ | (cm)² | (mPas)³ |
| milk | — | yes | 0.5 | No | 7.5 |
| (reference) | | | | sediment | |
| milk + 20% | — | yes | 1 | No | 8 |
| calcium | | | | sediment | |
| milk + 30% | 0.02 | yes | 1 | No | 11.8 |
| calcium | | | | sediment | |
| milk + 30% | — | yes | 1 | No | 8 |
| calcium | | | | sediment | |
| milk + 40% | 0.02 | yes | 1 | No | 12 |
| calcium | | | | sediment | |
| milk + 40% | — | yes | 1 | No | 8.3 |
| calcium | | | | sediment | |
| milk + 40% | — | no | 10 | 1.5 | 3.5 |
| calcium | | | | | |

¹after centrifugation for 10 min 200 g at 20° C in 50 ml Greiner centrifuge tubes
²after storage for 1 week at 30° C. at 1 g in a 0.5 L beaker
³at 300 sec⁻¹
⁴mixture of carrageenan (1.7%), CMC and dextrin.

Directly after production all samples looked stable and no inhomogeneities were observed. A small difference in sedimentation was found between the reference milk and most of the different calcium enriched milks under centrifugal conditions (2000 g, 10 min). However, one week storage at 30° C. did not result in sedimentation in all samples except the one that was not stabilized with the premix and/or extra carrageenan. The calcium-enriched milk without stabilizer (7) did show more sedimentation in both tests. The samples with extra calcium and carrageenan appear to have a yield stress, which is strong enough to stabilize the particles but hardly affects either the sensory behavior or the flow properties. Determination of the viscosity revealed differences. An increase was observed after the addition of calcium and after the addition of carrageenan.

1. A method for stabilizing and preventing coagulation of proteins in milk comprising a coagulant consisting of >400 ppm of a non-complexed divalent cation, and/or an amount of an acid giving a pH<6.2 to the milk, comprising the steps:
a) adding to the milk 0.0005 to 0.1% carrageenan and/or gellan as a hydrocolloid mixture comprising at least 0.2% carrageenan and/or gellan based on the total weight of the hydrocolloid mixture, and at least one of the divalent cation and the acid to obtain a solution or dispersion;
b) at least partially precipitating proteins from the solution or dispersion by heating the milk at 120-150° C. for 2 to 120 seconds;
c) cooling the mixture of step b) to below 100° C., preferably to below 40° C.; and
d) applying shear or elongation onto the precipitate to obtain a stabilized divalent cation protein solution or dispersion.

2. The method according to claim 1 wherein in step b) the proteins from the solution or dispersion are completely precipitated.

3. The method according to claim 1 for preventing coagulation of proteins in milk comprising >600 ppm of divalent cations.

4. The method according to claim 1 wherein in step a) the lactate and/or gluconate and/or lactobionate of Ca2+ and/or Mg2+ is added.

5. The method according to claim 1 wherein homogenizing is performed at a pressure of 50 bar or higher.

6. The method according to claim 1 wherein the hydrocolloid further comprises a compound selected from a modified starch, dextrin, maltodextrin, carboxymethylcellulose (CMC), pectin, guar, locust bean gum, xanthan, and traganth gum.

7. The method according to claim 1 wherein the shear or elongation is performed in a homogenizer.

8. A stabilized coagulant-containing milk comprising a coagulant consisting of >400 ppm of a divalent cation, and/or an amount of an acid giving a pH<6.2 to the milk.

9. The stabilized coagulant-containing milk of claim 8 wherein the milk is bovine or soy milk comprising >600 ppm Ca2+ ions.

10. The milk of claim 8 wherein the stabilized coagulant-containing milk is cat milk.

11. A spray-dry process utilizing the milk of claim 8.
